(19) United States
(12) Patent Application Publication
(10) Pub. No.: US 2017/0125056 A1
(43) Pub. Date: May 4, 2017

(54) SELECTION OF VIDEO IN RESPONSE TO A BIOMETRIC INDICATOR

(71) Applicant: SONY CORPORATION, Tokyo (JP)

(72) Inventor: CHRISTOPHER OHREN, SAN DIEGO, CA (US)

(21) Appl. No.: 14/931,728

(22) Filed: Nov. 3, 2015

(51) Int. Cl. G11B 27/031; H04N 5/91; G06K 9/00; H04N 5/77

(52) U.S. Cl. CPC G11B 27/031; H04N 5/77; H04N 5/91; G06K 9/00885; G06K 2009/00939

(57) ABSTRACT

A system has a video capture device, wherein the video capture device captures a video image; a biometric capture device, wherein the biometric capture device captures biometric data, wherein the video image and the biometric data are time synchronized; a storage device coupled to the video capture device and coupled to the biometric capture device, wherein the video image and the biometric data are stored on the storage device, wherein the storage device is a non-transitory storage device; a content selector coupled to the storage device, wherein the content selector selects at least one segment of the video image as a function of the biometric data passing a threshold; and a display device coupled to the storage device, wherein the display device displays the at least one segment.

### BACKGROUND OF THE INVENTION

### 1. Field of the Invention

The present invention relates generally to selection of a segment of video, and more specifically to automated selection of a segment of video in response to a biometric indicator. Even more specifically, the present invention relates to automated selection of a segment of video for storage, playback or sharing in response to a simultaneously-captured biometric indicator.

### 2. Discussion of the Related Art

Video recording devices are now quite common in the marketplace, including traditional television video recording devices, handheld camcorders, still cameras with video recording capabilities, portable telephones (such as cellular telephones) with video recording capabilities, and smart phones with video recording capabilities. As a result, individual users may capture enormous amounts of video, much of which may be uninteresting.

Video editing equipment and software tends to be clumsy, relatively slow to operate, and cumbersome. As such this enormous amount of video is often simply stored, and never edited for its most interesting components.

Furthermore, when captured on a cellular telephone or smart phone, large video files take inordinate amounts of time to transmit, and unnecessarily utilize bandwidth that individual customers may be paying for on a metered basis.

Thus, there is a need to reproduce the above described problems with video editing, thereby reducing the size of resultant video files so as to more efficiently utilize storage resources and bandwidth.

### SUMMARY OF THE INVENTION

Several embodiments of the invention advantageously address the needs above as well as other needs by providing automated selection of a segment of video for storage, playback or sharing in response to a simultaneously-captured biometric indicator.

In accordance with one embodiment, the present invention can be characterized as a system having a video capture device, wherein the video capture device captures a video image; a biometric capture device, wherein the biometric capture device captures biometric data, wherein the video image and the biometric data are time synchronized; a storage device coupled to the video capture device and coupled to the biometric capture device, wherein the video image and the biometric data are stored on the storage device, wherein the storage device is a non-transitory storage device; a content selector coupled to the storage device, wherein the content selector selects at least one segment of the video image as a function of the biometric data passing a threshold; and a display device coupled to the storage device, wherein the display device displays the at least one segment.

In accordance with another embodiment, the invention can be characterized as a system comprising a video capture device, wherein the video capture device captures a video image; a biometric capture device coupled to the video capture device, wherein the biometric capture device captures biometric data, wherein the video image and the biometric data are time synchronized; a data selection device coupled to the video capture device, wherein the data selection device receives the video image and the biometric data and selects at least one segment of the video image as a function of the biometric data corresponding in time to the at least one segment passing a threshold; a video output builder coupled to the data selection device, wherein the video output builder builds a resultant video in response to the selecting of the at least one segment; and a social networking interface coupled to the video output builder, wherein the social networking interface transmits the resultant video to a social network in response to the build of the resultant video.

In accordance with the further embodiment, the present invention can be characterized as a method comprising capturing a video image; capturing biometric data, wherein the video image and the biometric data are time synchronized; storing the video image, and the biometric data on a non-transitory storage device; selecting at least one segment of the video image as a function of the biometric data corresponding in time to the at least one segment passing a threshold; storing the at least one segment having been selected on the non-transitory storage device; and displaying the at least one segment on a display device.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a block diagram of a system for selection of video in response to a biometric indicator in accordance with one embodiment.

FIG. 2 is a flow chart of a method for selection of video in response to a biometric indicator in accordance with one embodiment.

FIG. 3 is a block diagram of the system of FIG. 1 wherein a resultant video image is “shared” via a social media platform.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

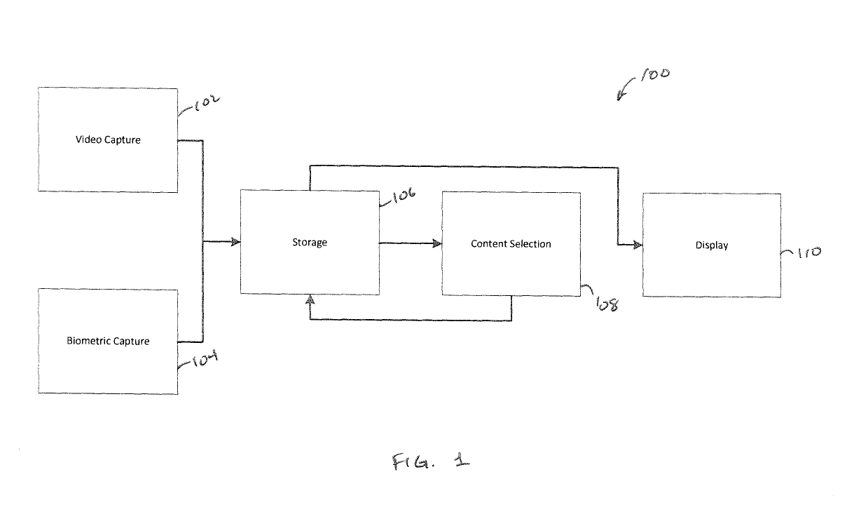

Referring first to FIG. 1, a block diagram 100 is shown of a system for selection of video in response to a biometric indicator in accordance with one embodiment.

Shown is a video capture device 102, a biometric capture device 104, a storage device 106, a content selection device 108, and a display device 110.

The video capture device 102 and the biometric capture device 104 each generate data indicative, respectively, of video images and biometric data, such as heart rate, respiration rate, perspiration, skin-galvanic response and/or the like. The video images and the biometric data are captured simultaneously, with the biometric data being captured from, for example, a person viewing the same scene captured in the video image as it is recorded. Alternatively, the biometric data may be captured at a later time from a person viewing the video image. Both the video image and the biometric data are output to the storage device 106, and stored therein.

In accordance with the present embodiment, the video image and the biometric data are passed to the content selection device 108, which selects segments of the video image as a function of the biometric data. For example, the content selection device 108 may select segments of the video image during which an elevated heart rate is detected. The selected segments are combined into a resultant video image and are saved to the storage device 106.

The resultant video images are then output to the display device 110, such as a display screen.

In operation, a person may be fitted with a simple biometric detector capable of detecting the heart rate of the person, such as a Bluetooth based heart rate detector communicatively coupled to the video capture device 102. The video capture device 102 may be, for example, a smartphone. The smartphone simultaneously records the video image and the biometric data and outputs the result to the storage device 106. The storage device 106 may be a memory within the smartphone, or may be an external memory, such as a storage archive, for example a network attached storage device or “the cloud”. The content selection device 108 reads the results from the storage device 106, and selects segments of the video image as a function of the biometric data. For example, elevated heart rate detected by the Bluetooth based heart rate detector may be used as a selection criteria. Segments of the video image meeting the selection criteria are selected, while segments of the video image not meeting the selection criteria are disregarded. The segments of the video image having been selected are then combined by the content selection device 108, which may be implemented as a software module in the smartphone, or may be separately implemented in hardware or software in a separate server, and communicated to and saved in the storage device 106.

The resultant video image, made up of the segments of the video image having been selected, are then transmitted from the storage device 106 to a display device 110, such as a video display, where the resultant video image can be viewed by an observer.

Alternatively, the segments of the video image having been selected may be displayed, for example, on the screen display of the smartphone, and the user may be prompted to save or reject each segment having been selected, with only the saved segments being combined into the resultant video image.

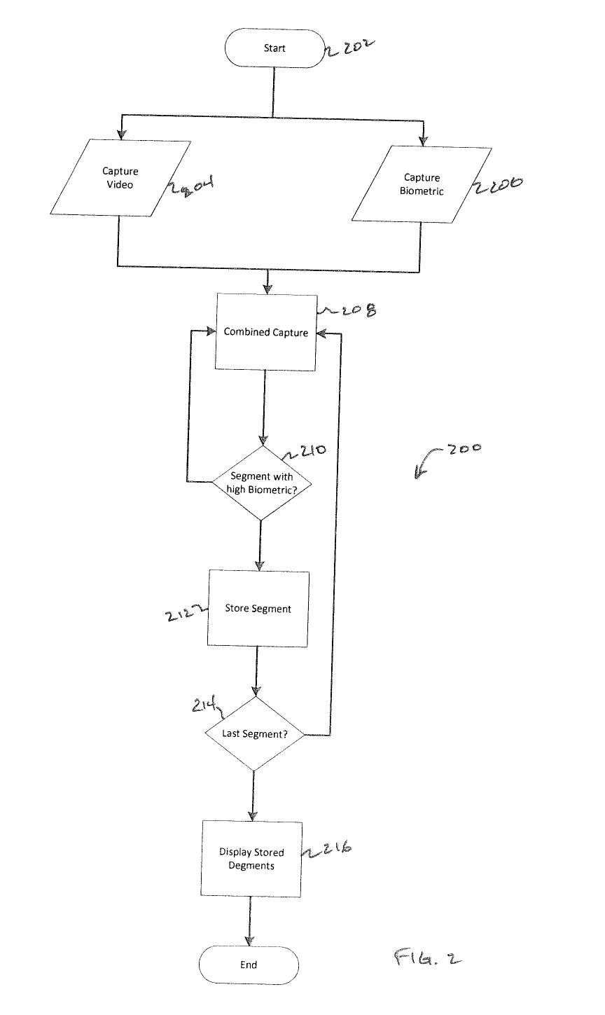

Referring next to FIG. 2, a flow chart 200 is shown of a method for selection of video in response to a biometric indicator in accordance with one embodiment.

At the outset 202, a video image is captured 204, and biometric data is captured 206, preferably simultaneously. In the alternative, the biometric data may be captured while a person on whom the biometric data is being captured is viewing the video image. The video image and the biometric data is combined 208 by synchronizing in time the video image and the biometric data.

Next, each segment of the biometric data is evaluated 210 to determine whether such a segment indicates that a biometric measurement exceeds a threshold, for example, a heart rate exceeds a threshold heart rate. When this evaluation determines that the biometric measurement exceeds the threshold, the corresponding (in time) segment of the video image is selected 212 for inclusion in a stored video image. This process is repeated 214 for all of the biometric data (and all of the video image corresponding in time thereto). The result of this iterative process is a resultant video image that represents all segments of the video image captured during periods when the biometric measurement exceeded the threshold.

The segments of the video image making up the resultant video image may further be displayed to the user for approval as to their inclusion in the final resultant video image. As such, the user may have final editorial authority as to which segments of the video image, having been selected for their correspondence with biometric measurements that exceed the threshold, are included within the final resultant video image.

In any case, the final resultant video image can then be displayed 216 to the user, or transmitted, such as via a communications network to a remote display device, such as another user's smartphone, and displayed on the remote display device. In addition, the final resultant video image can be “shared” via social media or otherwise utilized.

In this way, a substantial amount of undesirable video content within the video image can be deselected based on the biometric data, minimizing the effort required by the user to edit the video image down to only those segments of the video image that are of interest to the user.

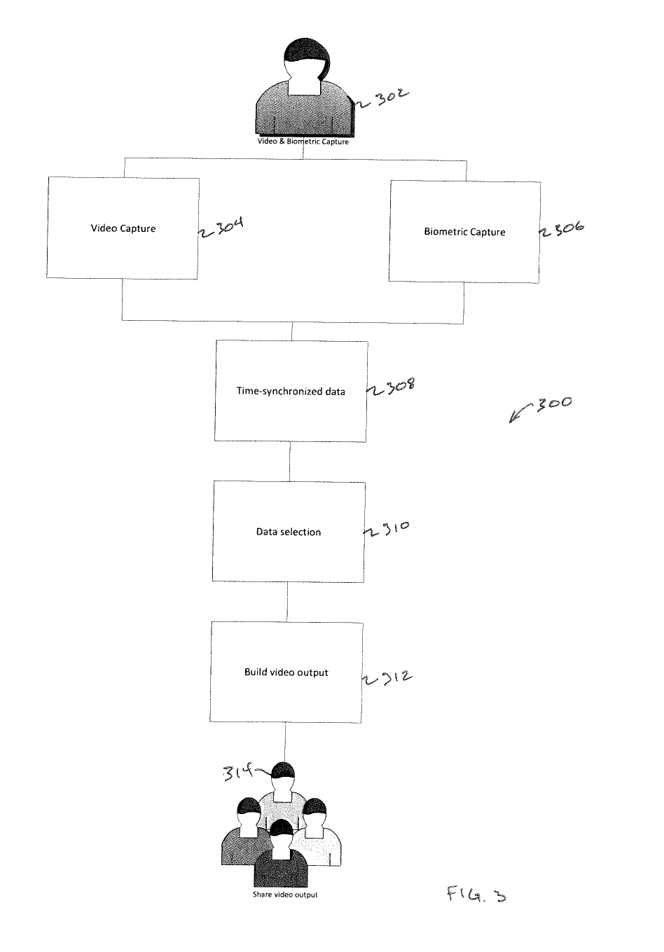

Referring next to FIG. 3, a block diagram 300 is shown of the system of FIG. 1 wherein a resultant video image is “shared” via a social media platform.

Shown is a user 302 with a video capture device 304 and a biometric capture device 306, a time synchronization repository 308, a data selection device 310, a video output builder 312, and a shared video output 314.

The video capture device 304 and the biometric capture device 306 each generate data indicative, respectively, of video images and biometric data, such as heart rate, respiration rate, perspiration, skin-galvanic response and/or the like. The video images and the biometric data are captured simultaneously, with the biometric data being captured from, for example, a person viewing the same scene captured in the video image as it is recorded, and a time-synchronized output is generated. Alternatively, the biometric data may be captured at a later time from a person viewing the video image. Both the video image and the biometric data are output to the data selection device.

In accordance with the present embodiment, the video image and the biometric data are passed to the data selection device 310 which selects segments of the video image as a function of the biometric data. For example, the data selection device may select segments of the video image during which an elevated heart rate is detected.

The selected segments are combined into a resultant video image by the build video output 312 where a resultant video image is built.

The resultant video image is then output to the shared video output 314, such as a social network.

In operation, the user may be fitted with a simple biometric detector 306 capable of detecting the heart rate of the person, such as a Bluetooth based heart rate detector communicatively coupled to the video capture device. The video capture device 304 may be, for example, a smartphone. The smartphone simultaneously records the video image and the biometric data and outputs the time-synchronized data 308. The time-synchronized data is output to the data selection device 310 that selects segments of the video image as a function of the biometric data, and prompts the user to approve or decline the selected segments. For example, elevated heart rate detected by the Bluetooth based heart rate detector may be used as a selection criteria. Segments of the video image meeting the selection criteria are selected, while segments of the video image not meeting the selection criteria are disregarded. The segments of the video image having been selected and approved by the user are then combined by build video output 312, which may be implemented as a software module in the smartphone, and the combined video image is then communicated to the shared video output 314.

While the invention herein disclosed has been described by means of specific embodiments, examples and applications thereof, numerous modifications and variations could be made thereto by those skilled in the art without departing from the scope of the invention set forth in the claims.

What is claimed is:

1. A system comprising:
a video capture device, wherein the video capture device captures a video image;
a biometric capture device, wherein the biometric capture device captures biometric data, wherein the video image and the biometric data are time synchronized;
a storage device coupled to the video capture device and coupled to the biometric capture device, wherein the video image and the biometric data are stored on the storage device, wherein the storage device is a non-transitory storage device;
a content selector coupled to the storage device, wherein the content selector selects at least one segment of the video image as a function of the biometric data passing a threshold; and
a display device coupled to the storage device, wherein the display device displays the at least one segment.

2. The system of claim 1 further comprising:
a smartphone, wherein the smartphone includes said video capture device, and said storage device, and said display device.

3. The system of claim 2 further comprising:
said smartphone, wherein said smartphone includes said content selector.

4. The system of claim 1 further comprising:
said display device, wherein said display device further displays at least one confirmation prompt in response to the content selector selecting the at least one segment; and
an input device, wherein the input device detects a confirmation input from a person in response to the at least one confirmation prompt, wherein the at least one segment is deselected in the event the confirmation input indicates the person does not confirm the at least one segment, wherein said display device does not display the at least one segment in the event the at least one segment is deselected.

5. The system of claim 1 further comprising:
a network coupled to said content selector and coupled to said display device, wherein the network is interposed between said content selector and said display device.

6. The system of claim 5 further comprising:
said network, wherein said network includes at least one social networking website.

7. A system comprising:
a video capture device, wherein the video capture device captures a video image;
a biometric capture device coupled to the video capture device, wherein the biometric capture device captures biometric data, wherein the video image and the biometric data are time synchronized;
a data selection device coupled to the video capture device, wherein the data selection device receives the video image and the biometric data and selects at least one segment of the video image as a function of the biometric data corresponding in time to the at least one segment passing a threshold;
a video output builder coupled to the data selection device, wherein the video output builder builds a resultant video in response to the selecting of the at least one segment; and
a social networking interface coupled to the video output builder, wherein the social networking interface transmits the resultant video to a social network in response to the build of the resultant video.

8. The system of claim 7 further comprising:
a smartphone, wherein the smartphone includes said data selection device.

9. The system of claim 8 further comprising:
said smartphone, wherein said smartphone includes said video output builder.

10. The system of claim 7 further comprising:
a display device coupled to the video output builder, wherein the display device displays the at least one segment.

11. The system of claim 10 further comprising:
said display device, wherein the display device further displays at least one confirmation prompt in response to the content selector selecting the at least one segment; and
an input device, wherein the input device detects a confirmation input from a person in response to the at least one confirmation prompt, wherein the at least one segment is deselected in the event the confirmation input indicates the person does not confirm the at least one segment, wherein said display device does not display the at least one segment in the event the at least one segment is deselected.

12. The system of claim 7 further comprising:
said video output builder, wherein said video output builder generates at least one confirmation prompt in response to the data selection device selecting the at least one segment; and
an input device, wherein the input device detects a confirmation input from a person in response to the at least one confirmation prompt, wherein the at least one segment is deselected in the event the confirmation input indicates the person does not confirm the at least one segment, wherein said video output builder does not build the resultant video in response to the at least one segment in the event the at least one segment is deselected.

13. A method comprising:
capturing a video image;
capturing biometric data, wherein the video image and the biometric data are time synchronized;
storing the video image, and the biometric data on a non-transitory storage device;
selects at least one segment of the video image as a function of the biometric data corresponding in time to the at least one segment passing a threshold;
storing the at least one segment having been selected on the non-transitory storage device; and
displaying the at least one segment on a display device.
